(19) United States
(12) Patent Application Publication
(10) Pub. No.: US 2010/0120618 A1
(43) Pub. Date: May 13, 2010

(54) HERBICIDAL COMPOSITION

(75) Inventors: Georg Rüdiger Kotzian, Basel (CH); Gavin John Hall, Bracknell (GB)

Correspondence Address: SYNGENTA CROP PROTECTION , INC.;PATENT AND TRADEMARK DEPARTMENT, 410 SWING ROAD, GREENSBORO, NC, 27409, US

(73) Assignee: SYNGENTA CROP PROTECTION, INC., Greensboro, NC (US)

(21) Appl. No.: 12/524,794

(22) PCT Filed: Jan. 28, 2008
(86) PCT No.: PCT/EP2008/000632

§ 371 Date: Jul. 28, 2009

(30) Foreign Application Priority Data
Jan. 29, 2007 (CH) 0139/07
Sep. 26, 2007 (CH) 1498/07

(51) Int. Cl. A01N 43/56; A01P 13/00

(52) U.S. Cl. 504/139

(57) ABSTRACT

A herbicidal composition comprising as active ingredient a mixture of pinoxaden, safeners and an additive.

The present invention relates to novel herbicidal compositions for controlling grasses and weeds in crops of useful plants, comprising pinoxaden as herbicide and cyprosulfamide, known as a safener (counter-agent, antidote), or diflufenzopyr, known as a herbicide. The present invention relates also to the use of such compositions for controlling grasses and weeds in crops of useful plants, especially in all cereal crops, but also in rice, cotton, rape, canola, potatoes and soybeans.

The use of herbicides can result in considerable damage also being caused to crop plants, for example in dependence upon the concentration of the herbicide and the mode of its application, the crop plant, the nature of the soil and the climatic conditions, such as period of exposure to light, temperature and amounts of precipitation. In order to counter those problems, various substances have already been proposed as safeners that are capable of protecting the crop plant against the damaging action of the herbicide, while the herbicidal activity on the grasses and weeds to be controlled is virtually unimpaired. It has been found that the proposed safeners often have a very specific action both in respect of the crop plants and in respect of the herbicide and in some cases also in dependence upon the mode of application. This means that a specific safener is often suitable only for a specific crop plant and a particular class of herbicide or only a specific herbicide.

Surprisingly, it has now been found that cyprosulfamide and diflufenzopyr are capable of enhancing the herbicidal activity of pinoxaden on weeds and grasses, without having any appreciable effect on the useful plants.

According to the invention, therefore, there is proposed a herbicidal composition which, in addition to comprising formulation adjuvants, such as carriers, solvents and surface-active substances, comprises as active ingredient a mixture of

a) a herbicidally effective amount of pinoxaden,

b) cyprosulfamide or diflufenzopyr in an amount that enhances the herbicidal activity of pinoxaden,

c) optionally a further safener and

d) an additive.

Pinoxaden and cyprosulfamide are described, for example, in WO 99/47525 or EP-A-1 019 368. A description of diflufenzopyr can be found, for example, in The Pesticide Manual, Twelfth Edition, BCPC, under number 246.

Cyprosulfamide is the preferred component b).

The invention relates also to a method of controlling grasses and weeds in crops of useful plants, which comprises treating the useful plants or seeds or cuttings thereof or the area under cultivation with a composition according to the invention.

As crop plants there come into consideration especially all cereal and rice crops, and also cotton, rape, canola, potatoes and soybeans. Cereals and rice are the most important. The term “crops” is to be understood as also including crops that have been rendered tolerant to herbicides or classes of herbicides (for example ALS, GS, EPSPS, PPO and HPPD inhibitors) as a result of conventional methods of breeding or genetic engineering.

An example of a crop that has been rendered tolerant e.g. to imidazolinones, such as imazamox, by conventional methods of breeding is Clearfield® summer rape (Canola). Examples of crops that have been rendered tolerant to herbicides by genetic engineering methods include e.g. glyphosate- and glufosinate-resistant maize varieties commercially available under the trade names RoundupReady® and LibertyLink®, respectively.

Crops are also to be understood as being those which have been rendered resistant to harmful insects by genetic engineering methods, for example Bt maize (resistant to European corn borer), Bt cotton (resistant to cotton boll weevil) and also Bt potatoes (resistant to Colorado beetle). Examples of Bt maize are the Bt-176 maize hybrids of NK® (Syngenta Seeds). The Bt toxin is a protein that is formed naturally by Bacillus thuringiensis soil bacteria. Examples of toxins and transgenic plants able to synthesise such toxins are described in EP-A-451 878, EP-A-374 753, WO 93/07278, WO 95/34656, WO 03/052073 and EP-A-427 529. Examples of transgenic plants that contain one or more genes which code for an insecticidal resistance and express one or more toxins are KnockOut® (maize), Yield Gard® (maize), NuCOTIN33B® (cotton), Bollgard® (cotton), NewLeaf® (potatoes), NatureGard® and Protexcta®. Plant crops and their seed material can be resistant to herbicides and at the same time also to insect feeding (“stacked” transgenic events). Seed can, for example, have the ability to express an insecticidally active Cry3 protein and at the same time be glyphosate-tolerant. The term “crops” also includes those obtained by conventional methods of breeding or genetic engineering and contain so-called output traits (for example improved storage stability, higher nutritional value and improved flavour).

Areas under cultivation are to be understood as including land where the crop plants are already growing or where seed material of the crop plants has been sown as well as land intended for the cultivation of those crop plants.

The weeds to be controlled can be both monocotyledonous and dicotyledonous weeds, for example Stellaria, Nasturtium, Agrostis, Digitaria, Avena, Setaria, Sinapis, Lolium, Solanum, Echinochloa, Scirpus, Monochoria, Sagittaria, Bromus, Alopecurus, Sorghum, Rottboellia, Cyperus, Abutilon, Sida, Xanthium, Amaranthus, Chenopodium, Ipomoea, Chrysanthemum, Galium, Viola, Apera, Phalaris and Veronica. Preference is given to the control of Agrostis, Digitaria, Avena, Setaria, Lolium, Echinochloa, Bromus, Alopecurus, Apera and Phalaris. Special preference is given to the control of Avena, Setaria, Lolium, Echinochloa, Bromus, Alopecurus, Apera and Phalaris.

The compositions according to the invention are suitable for all methods of application customary in agriculture, such as, for example, pre-emergence application, post-emergence application and seed dressing. Depending upon the intended use, component b) and optionally c) can be used for pretreating the seed material of the crop plant (dressing the seed or cuttings) or introduced into the soil before or after sowing. It can, however, also be applied alone or together with pinoxaden before or after emergence of the plants. The treatment of the plants or the seed material with component b) and optionally c) can therefore take place in principle independently of the time of application of the pinoxaden. The treatment of the plant by simultaneous application of pinoxaden and component b) and optionally c) (e.g. in the form of a tank mixture) is generally preferred. The rate of application of component b) and optionally c) relative to pinoxaden is largely dependent upon the mode of application. In the case of field treatment, generally from 0.001 to 5.0 kg of component b) and optionally c)/ha, preferably from 0.001 to 0.5 kg of component b) and optionally c)/ha, and generally from 0.001 to 2 kg of pinoxaden/ha, but preferably from 0.005 to 1 kg/ha, are applied. In the case of seed dressing, generally from 0.001 to 500 g of component b) and optionally c)/kg of seed, preferably from 0.05 to 50 g of component b) and optionally c)/kg of seed, are applied. When component b) and optionally c) is applied in liquid form, with seed soaking, shortly before sowing, it is advantageous to use solutions which contain the active ingredient in a concentration of from 1 to 10 000 ppm, preferably from 100 to 1000 ppm. The mixture of a herbicidally effective amount of pinoxaden and an amount of component b) and optionally c) that enhances the herbicidal activity of pinoxaden can be used in unmodified form as a herbicidal composition. The compositions according to the invention are, however, generally formulated in a variety of ways using formulation adjuvants, such as carriers, solvents and surface-active substances. The formulations can be in various physical forms, for example in the form of dusting powders, gels, wettable powders, water-dispersible granules, water-dispersible tablets, effervescent compressed tablets, emulsifiable concentrates, microemulsifiable concentrates, oil-in-water emulsions, oil flowables, aqueous dispersions, oily dispersions, suspoemulsions, capsule suspensions, emulsifiable granules, soluble liquids, water-soluble concentrates (with water or a water-miscible organic solvent as carrier), impregnated polymer films or in other forms known, for example, from the Manual on Development and Use of FAO Specifications for Plant Protection Products, 5th Edition, 1999. Such formulations can either be used directly or are diluted prior to use. Diluted formulations can be prepared, for example, with water, liquid fertilisers, micronutrients, biological organisms, oil or solvents.

The formulations can be prepared, for example, by mixing the active ingredient, that is to say pinoxaden and component b) and optionally c), with formulation adjuvants in order to obtain compositions in the form of finely divided solids, granules, solutions, dispersions or emulsions. The active ingredients can also be formulated with other adjuvants, for example finely divided solids, mineral oils, oils of vegetable or animal origin, modified oils of vegetable or animal origin, organic solvents, water, surface-active substances or combinations thereof. The active ingredients can also be contained in very fine microcapsules consisting of a polymer. Microcapsules contain the active ingredients in a porous carrier. This enables the active ingredients to be released into their surroundings in controlled amounts (e.g. slow release). Microcapsules usually have a diameter of from 0.1 to 500 microns. They contain active ingredients in an amount of about from 25 to 95% by weight of the capsule weight. The active ingredients can be present in the form of a monolithic solid, in the form of fine particles in solid or liquid dispersion or in the form of a suitable solution. The encapsulating membranes comprise, for example, natural and synthetic gums, cellulose, styrene-butadiene copolymers, polyacrylonitrile, polyacrylate, polyester, polyamides, polyureas, polyurethane or chemically modified polymers and starch xanthates or other polymers that are known to the person skilled in the art in this connection. Alternatively it is possible for very fine microcapsules to be formed wherein the active ingredient is present in the form of finely divided particles in a solid matrix of a base substance, but in that case the microcapsule is not encapsulated.

The formulation adjuvants suitable for the preparation of the compositions according to the invention are known per se. As liquid carriers there may be used: water, toluene, xylene, petroleum ether, vegetable oils, acetone, methyl ethyl ketone, cyclohexanone, acid anhydrides, acetonitrile, acetophenone, amyl acetate, 2-butanone, butylene carbonate, chlorobenzene, cyclohexane, cyclohexanol, alkyl esters of acetic acid, diacetone alcohol, 1,2-dichloropropane, diethanolamine, p-diethylbenzene, diethylene glycol, diethylene glycol abietate, diethylene glycol butyl ether, diethylene glycol ethyl ether, diethylene glycol methyl ether, N,N-dimethylformamide, dimethyl sulfoxide, 1,4-dioxane, dipropylene glycol, dipropylene glycol methyl ether, dipropylene glycol dibenzoate, diproxitol, alkylpyrrolidone, ethyl acetate, 2-ethyl hexanol, ethylene carbonate, 1,1,1-trichloroethane, 2-heptanone, alpha-pinene, d-limonene, ethylene glycol, ethyl lactate, ethylene glycol butyl ether, ethylene glycol methyl ether, gamma-butyrolactone, glycerol, glycerol acetate, glycerol diacetate, glycerol triacetates, hexadecane, hexylene glycol, isoamyl acetate, isobornyl acetates, isooctane, isophorone, isopropylbenzene, isopropyl myristate, lactic acid, laurylamine, mesityl oxide, methoxypropanol, methyl isoamyl ketone, methyl isobutyl ketone, methyl laurate, methyl octanoate, methyl oleate, methylene chloride, m-xylene, n-hexane, n-octylamine, octadecanoic acid, octylamine acetate, oleic acid, oleylamine, o-xylene, phenol, polyethylene glycol (PEG 400), propionic acid, propyl lactate, propylene carbonate, propylene glycol, propylene glycol methyl ether, p-xylene, toluene, triethyl phosphate, triethylene glycol, xylenesulfonic acid, paraffin, mineral oil, trichloroethylene, perchloro-ethylene, ethyl acetate, amyl acetate, butyl acetate, propylene glycol methyl ether, diethylene glycol methyl ether, methanol, ethanol, isopropanol, and higher molecular weight alcohols, such as amyl alcohol, tetrahydrofurfuryl alcohol, hexanol, octanol, ethylene glycol, propylene glycol, glycerol, N-methyl-2-pyrrolidone and the like. Water is generally the carrier of choice for the dilution of the concentrates. Suitable solid carriers are, for example, talc, titanium dioxide, pyrophyllite clay, silica, attapulgite clay, kieselguhr, limestone, calcium carbonate, bentonite, calcium montomorillonite, cottonseed husks, wheatmeal, soybean flour, pumice, wood flour, ground walnut shells, lignin and similar materials, as described, for example, in CFR 180.1001. (c) & (d). A large number of surface-active substances can advantageously be used both in solid and in liquid formulations, especially in those formulations which can be diluted with a carrier prior to use. Surface-active substances may be anionic, cationic, non-ionic or polymeric and they may be used as emulsifiying, wetting or suspending agents or for other purposes. Typical surface-active substances include, for example, salts of alkyl sulfates, such as diethanolammonium lauryl sulfate; salts of alkylarylsulfonates, such as calcium dodecylbenzenesulfonate; alkylphenol-alkylene oxide addition products, such as nonylphenol ethoxylate; alcohol-alkylene oxide addition products, such as tridecyl alcohol ethoxylate; soaps, such as sodium stearate; salts of alkylnaphthalenesulfonates, such as sodium dibutylnaphthalenesulfonate; dialkyl esters of sulfosuccinate salts, such as sodium di(2-ethylhexyl)sulfosuccinate; sorbitol esters, such as sorbitol oleate; quaternary amines, such as lauryl trimethylammonium chloride, polyethylene glycol esters of fatty acids, such as polyethylene glycol stearate; block copolymers of ethylene oxide and propylene oxide; and salts of mono- and di-alkyl phosphate esters; and also further substances described e.g. in “McCutcheon's Detergents and Emulsifiers Annual”, MC Publishing Corp., Ridgewood, N.J., 1981.

Further adjuvants which can usually be used in pesticidal formulations include crystallisation inhibitors, viscosity-modifying substances, suspending agents, dyes, anti-oxidants, foaming agents, light absorbers, mixing aids, anti-foams, complexing agents, neutralising or pH-modifying substances and buffers, corrosion-inhibitors, fragrances, wetting agents, absorption improvers, micronutrients, plasticisers, glidants, lubricants, dispersants, thickeners, anti-freezes, microbiocides, and also liquid and solid fertilisers. The formulations may also comprise additional active substances, for example further herbicides, plant growth regulators, fungicides or insecticides.

The compositions according to the invention can additionally include an additive (component d)) comprising an oil of vegetable or animal origin, a mineral oil, alkyl esters of such oils or mixtures of such oils and oil derivatives. Preferably, the oil additive can be added to the spray tank in the desired concentration after the spray mixture has been prepared. For example, spray mixtures according to the invention can contain the oil additive in an amount of from 0.01 to 10%, especially from 0.1 to 5% and more especially from 0.1 to 2.5%, based on the volume of the spray mixture. Preferred oil additives comprise mineral oils or an oil of vegetable origin, for example rapeseed oil, olive oil or sunflower oil, emulsified vegetable oil, such as AMIGO® (Rhône-Poulenc Canada Inc.), alkyl esters of oils of vegetable origin, for example the methyl derivatives, or an oil of animal origin, such as fish oil or beef tallow. A preferred additive contains, for example, as active components essentially 80% by weight alkyl esters of fish oils and 15% by weight methylated rapeseed oil, and also 5% by weight of customary emulsifiers and pH modifiers. Especially preferred oil additives comprise alkyl esters of C₈-C₂₂ fatty acids, with particular importance being attached to the methyl derivatives of C₁₂-C₁₈ fatty acids, for example the methyl esters of lauric acid, palmitic acid and oleic acid. Those esters are known as methyl laurate (CAS-111-82-0), methyl palmitate (CAS-112-39-0) and methyl oleate (CAS-112-62-9). A preferred fatty acid methyl ester derivative is Emery® 2230 and 2231 (Cognis GmbH) and especially Agnique ME 18 RD-F®. Those and other suitable oil derivatives are also known from the Compendium of Herbicide Adjuvants, 5th Edition, Southern Illinois University, 2000.

The application and action of the oil additives can be improved still further by combining them with surface-active substances, such as non-ionic, anionic or cationic surfactants. Examples of suitable anionic, non-ionic and cationic surfactants are listed on pages 7 and 8 of WO 97/34485. Preferred surface-active substances are anionic surfactants of the dodecylbenzylsulfonate type, especially the calcium salts thereof, and also non-ionic surfactants of the fatty alcohol ethoxylate type. Special preference is given to ethoxylated C₁₂-C₂₂ fatty alcohols having a degree of ethoxylation of from 5 to 40. Examples of commercially available surfactants are the Genapol types (Clariant AG) and EMULSOGEN M®. Also preferred are silicone surfactants, especially polyalkyl-oxide-modified heptamethyl-trisiloxanes, which are commercially available e.g. as Silwet L-77®, and also perfluorinated surfactants. The concentration of surface-active substances in relation to the total additive is generally from 1 to 30% by weight. Examples of oil additives that consist of mixtures of oils or mineral oils or derivatives thereof with surfactants are Edenor ME SU®, Turbocharge® (Syngenta Agro, CH) and Actipron® (BP Oil UK Limited, GB).

The said surface-active substances may also be used in the formulations alone, that is to say without oil additives.

Furthermore, the addition of an organic solvent to the oil additive/surfactant mixture can contribute to a further enhancement of action. Suitable solvents are, for example, SOLVESSO 200 ND® (ESSO) and Aromatic Solvent® (Exxon Corporation).The concentration of such solvents can be from 10 to 80% by weight of the total weight. Such oil additives, which may be in admixture with solvents, are described, for example, in U.S. Pat. No. 4,834,908. A commercially available oil additive disclosed therein is known by the name MERGE® (BASF Corporation). A further oil additive that is preferred according to the invention is SCORE® (Syngenta Crop Protection Canada.)

In addition to the oil additives listed above, in order to enhance the activity of the compositions according to the invention it is also possible for formulations of alkylpyrrolidones, (e.g. Agrimax®) to be added to the spray mixture. Formulations of synthetic latices, such as, for example, polyacrylamide, polyvinyl compounds or poly-1-p-menthene (e.g. Bond®, Courier® or Emerald®) can also be used. Solutions that contain propionic acid, for example Eurogkem Pen-e-trate®, can also be mixed into the spray mixture as activity-enhancing agents.

An especially preferred additive (component d)) has proved to be a mixture containing rapeseed oil methyl ester (e.g. AGNIQUE ME 18 RD-F), ethoxylated alcohol (e.g. EMULSOGEN M) and aromatic hydrocarbons (e.g. SOLVESSO 200 MD) as solvent. The mentioned additives are generally added to the spray tank in the desired concentration after the spray mixture has been prepared. There are also additives, however, that are preferably already present in the formulation of the active ingredients, for example those containing phosphates or phosphonates known from WO 01/47356 and WO 00/56146. For the compositions according to the invention there come into consideration especially the phosphate-containing additives mentioned in those two documents, especially those containing alkyl phosphates. A preferred example of an alkyl phosphate is tris(2-ethylhexyl)phosphate. Preferably such so-called built-in additives containing a phosphate are present in the formulations in amounts of from 15 to 40% by weight.

The compositions according to the invention can also comprise further safeners (component c)), for example cloquintocet-mexyl, mefenpyr-diethyl or isoxadifen-ethyl. Cloquintocet-mexyl is of special importance. The amount of safener component c) in the compositions according to the invention is preferably from 10 to 50%, especially from 10 to 25%, of the amount of pinoxaden. Cloquintocet-mexyl, mefenpyr-diethyl and isoxadifenethyl can be found, for example, in The e-Pesticide Manual, Thirteenth Edition, BCPC, Version 3.2, 2005-06 under numbers 163, 506 and 478, respectively.

The herbicidal formulations according to the invention generally contain from 0.1 to 99% by weight, especially from 0.1 to 95% by weight, active ingredient mixture of pinoxaden and component b) and optionally c), and from 15 to 40% by weight additive (component d)) and from 1 to 99.9% by weight of a formulation adjuvant which preferably contains from 0 to 50% by weight of a surface-active substance. When the additive is added to the spray mixture in the spray tank, it is generally added in an amount of from 0.01 to 10% by weight of the amount of water used. Whereas commercial products will preferably be formulated as concentrates, the end user will normally employ dilute formulations.

Various methods and techniques come into consideration for the use of the compositions according to the invention, for example the following:

i) Seed Dressing

a) Dressing the seeds with a wettable powder formulation of component b) and optionally c) by shaking in a vessel until the formulation is evenly distributed over the surface of the seeds (dry dressing). In this method about from 1 to 500 g of component b) and optionally c) (from 4 g to 2 kg of wettable powder) are used per 100 kg of seed material.

b) Dressing the seeds with an emulsifiable concentrate of component b) and optionally c) in accordance with method a) (wet dressing).

c) Dressing by immersing the seed material in a liquor containing from 100 to 1000 ppm of component b) and optionally c) for 1 to 72 hours and optionally subsequently drying the seeds (immersion dressing).

Dressing the seed material or treating the germinated seedling are naturally the preferred methods of application, because the treatment with the active ingredient is directed entirely at the target crop. It is customary to use from 1 to 1000 g of component b) and optionally c), especially from 5 to 250 g of component b) and optionally c), per 100 kg of seed material, but depending upon the method used, which also allows the addition of other active ingredients or micronutrients, it is possible to use concentrations above and below the limits indicated (repeat dressing).

ii) Application in the Form of a Tank Mixture

A liquid formulation of a mixture of component b) and optionally c) and pinoxaden (in a respective quantity ratio of from 10:1 to 1:100) is used, the rate of application of pinoxaden being from 0.005 to 5.0 kg per hectare. Such tank mixtures are applied before or after sowing.

iii) Application to the Seed Furrow

Component b) and optionally c) is introduced into the open, sown seed furrow in the form of an emulsifiable concentrate, wettable powder or granules. When the seed furrow has been covered over, the herbicide is applied by the pre-emergence method in customary manner.

iv) Controlled Release of Active Ingredient

A solution of component b) and optionally c) is applied to granular mineral carriers or polymerised granules (urea/formaldehyde) and dried. If desired, a coating can be applied (coated granules), which allows the active ingredient to be released in metered amounts over a specific period of time.

Preferred formulations have especially the following compositions (%=percent by weight; “active ingredient mixture” denotes a mixture of pinoxaden and component b) and optionally c)):

| | |
|---|---|
| Emulsifiable concentrates: | |
| active ingredient mixture: | 1 to 95%, preferably 60 to 90% |
| surface-active agent: | 1 to 30%, preferably 5 to 20% |
| liquid carrier: | 1 to 80%, preferably 1 to 35% |
| Dusts: | |
| active ingredient mixture: | 0.1 to 10%, preferably 0.1 to 5% |
| solid carrier: | 99.9 to 90%, preferably 99.9 to 99% |
| Suspension concentrates: | |
| active ingredient mixture: | 5 to 75%, preferably 10 to 50% |
| water: | 94 to 24%, preferably 88 to 30% |
| surface-active agent: | 1 to 40%, preferably 2 to 30% |
| Wettable powders: | |
| active ingredient mixture: | 0.5 to 90%, preferably 1 to 80% |
| surface-active agent: | 0.5 to 20%, preferably 1 to 15% |
| solid carrier: | 5 to 95%, preferably 15 to 90% |
| Granules: | |
| active ingredient mixture: | 0.1 to 30%, preferably 0.1 to 15% |
| solid carrier: | 99.5 to 70%, preferably 97 to 85% |

The following Examples further illustrate, but do not limit, the invention.

Formulation Examples for mixtures of pinoxaden and component b) and optionally c) (%=percent by weight)

| F1. Emulsifiable concentrates | a) | b) | c) | d) |
|---|---|---|---|---|
| active ingredient mixture | 5% | 10% | 25% | 50% |
| calcium dodecylbenzene- | 6% | 8% | 6% | 8% |
| sulfonate | | | | |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| NMP | — | — | 10% | 20% |
| arom. hydrocarbon | 85% | 78% | 55% | 16% |
| mixture C₉-C₁₂ | | | | |

Emulsions of any desired concentration can be prepared from such concentrates by dilution with water.

| F2. Solutions | a) | b) | c) | d) |
|---|---|---|---|---|
| active ingredient mixture | 5% | 10% | 50% | 90% |
| 1-methoxy-3-(3-methoxy- | — | 20% | 20% | — |
| propoxy)-propane | | | | |
| polyethylene glycol MW 400 | 20% | 10% | — | — |
| NMP | — | — | 30% | 10% |
| arom. hydrocarbon | 75% | 60% | — | — |
| mixture C₉-C₁₂ | | | | |

The solutions are suitable for application in the form of microdrops.

| F3. Wettable powders | a) | b) | c) | d) |
|---|---|---|---|---|
| active ingredient mixture | 5% | 25% | 50% | 80% |
| sodium lignosulfonate | 4% | — | 3% | — |
| sodium lauryl sulfate | 2% | 3% | — | 4% |
| sodium diisobutylnaphthalene- | — | 6% | 5% | 6% |
| sulfonate | | | | |
| octylphenol polyglycol ether | — | 1% | 2% | — |
| (7-8 mol of ethylene oxide) | | | | |
| highly disperse silicic acid | 1% | 3% | 5% | 10% |
| kaolin | 88% | 62% | 35% | — |

The active ingredient is thoroughly mixed with the adjuvants and the mixture is thoroughly ground in a suitable mill, yielding wettable powders which can be diluted with water to give suspensions of any desired concentration.

| F4. Coated granules | a) | b) | c) |
|---|---|---|---|
| active ingredient mixture | 0.1% | 5% | 15% |
| highly disperse silicic acid | 0.9% | 2% | 2% |
| inorg. carrier | 99.0% | 93% | 83% |
| (diameter 0.1-1 mm) | | | |
| e.g. CaCO₃ or SiO₂ | | | |

The active ingredient is dissolved in methylene chloride, the solution is sprayed onto the carrier and the solvent is subsequently evaporated off in vacuo.

| F5. Coated granules | a) | b) | c) |
|---|---|---|---|
| active ingredient mixture | 0.1% | 5% | 15% |
| polyethylene glycol MW 200 | 1.0% | 2% | 3% |
| highly disperse silicic acid | 0.9% | 1% | 2% |
| inorg. carrier | 98.0% | 92% | 80% |
| (diameter 0.1-1 mm) | | | |
| e.g. CaCO₃ or SiO₂ | | | |

The finely ground active ingredient is applied uniformly, in a mixer, to the carrier moistened with polyethylene glycol. Non-dusty coated granules are obtained in this manner.

| F6. Extruder granules | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed and ground with the adjuvants and the mixture is moistened with water. The resulting mixture is extruded and then dried in a stream of air.

| F7. Dusts | a) | b) | c) |
|---|---|---|---|
| active ingredient mixture | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

| F8. Suspension concentrates | a) | b) | c) | d) |
|---|---|---|---|---|
| active ingredient mixture | 3% | 10% | 25% | 50% |
| ethylene glycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde | 0.2% | 0.2% | 0.2% | 0.2% |
| solution | | | | |
| silicone oil emulsion | 0.8% | 0.8% | 0.8% | 0.8% |
| water | 87% | 79% | 62% | 38% |

The finely ground active ingredient is intimately mixed with the adjuvants, yielding a suspension concentrate from which suspensions of any desired concentration can be prepared by dilution with water.

It is often more practical for pinoxaden and component b) and optionally c) to be formulated separately and then to be combined in the applicator in the desired mixing ratio in the form of a “tank mixture” in water shortly before application.

The ability of component b) and optionally c) to enhance the herbicidal activity of pinoxaden on weeds and grasses is illustrated in the following Examples.

### BIOLOGICAL EXAMPLES

### Example B1

### Post-Emergence Test

The test plants (Avena and winter wheat) are raised under greenhouse conditions in seed trays to a post-application stage (1.5- to 2-leaf stage). Pinoxaden is then applied to the test plants either alone or in admixture with component b) and optionally c). For both applications an additive is used which contains per litre 45% by weight Agnique ME 18 RD-F and 25% by weight Emulsogen M in Solvesso 200 ND. Application of pinoxaden is effected in the form of an emulsifiable concentrate (EC 100), and component b) and optionally c) is used in the form of WP 25. Those formulations are used to prepare spray mixtures, each of 200 litres, which contain 50 g or 100 g of pinoxaden and component b) and optionally c) and in each case 0.5% of additive (based on the volume of the spray mixtures). The tests are evaluated 21 days after application (herbicidal activity 100%=plant completely dead; herbicidal activity 0%=no phytotoxic action on the plant). The results, which are values averaged from 3 tests, are compiled in the following Table.

TABLE
Enhancement of the herbicidal activity of pinoxaden on
Avena and winter wheat

| | Herbicidal activity on | |
|---|---|---|
| Active substance in 200 I of spray mixture | Avena | Winter wheat |
| 50 g/ha pinoxaden + 0.5% additive | 82% | 8% |
| 50 g/ha pinoxaden + 50 g/ha cyprosulfamide + | 93% | 10% |
| 0.5% additive | | |
| 100 g/ha pinoxaden + 0.5% additive | 87% | 8% |
| 100 g/ha pinoxaden + 100 g/ha | 98% | 7% |
| cyprosulfamide + 0.5% additive | | |

What is claimed is:

1. A herbicidal composition comprising as active ingredient a mixture of
a) a herbicidally effective amount of pinoxaden,
b) cyprosulfamide or diflufenzopyr in an amount that enhances the herbicidal activity of pinoxaden,
c) optionally a further safener and
d) an additive.

2. A herbicidal composition according to claim 1, comprising cyprosulfamide as component b).

3. A herbicidal composition according to claim 1, comprising cloquintocet-mexyl, mefenpyrdiethyl or isoxadifen-ethyl as further component c).

4. A herbicidal composition according to claim 3, comprising cloquintocet-mexyl as further component c).

5. A herbicidal composition according to claim 1, comprising a mixture of rapeseed oil methyl ester, ethoxylated alcohol and aromatic hydrocarbons as component d).

6. A herbicidal composition according to claim 5, wherein component d) is added to the spray mixture.

7. A herbicidal composition according to claim 1, wherein component d) comprises an alkyl phosphate.

8. A herbicidal composition according to claim 7, wherein component d) is added to the formulation.

9. A method of controlling weeds and grasses in crops of useful plants, which comprises treating the useful plants or seeds or cuttings thereof or the area under cultivation with a herbicidal composition according to claim 1.

10. A method according to claim 9, wherein the crop of useful plants is cereal or rice.
